(19) United States
(12) Patent Application Publication
(10) Pub. No.: US 2021/0250884 A1
(43) Pub. Date: Aug. 12, 2021

(54) SYNCHRONIZATION IN MULTI-HOP NR IAB DEPLOYMENT

(71) Applicant: CONVIDA WIRELESS, LLC, Wilmington, DE (US)

(72) Inventors: Lakshmi R. IYER, King of Prussia, PA (US); Guodong ZHANG, Woodbury, NY (US); Qing LI, Princeton Junction, NJ (US); Yifan LI, Conshohocken, PA (US); Joseph M. MURRAY, Schwenksville, PA (US); Mohamed AWADIN, Plymouth Meeting, PA (US); Allan Y. TSAI, Boonton, NJ (US); Pascal M. ADJAKPLE, Great Neck, NY (US)

(21) Appl. No.: 16/973,294

(22) PCT Filed: Jun. 19, 2019
(86) PCT No.: PCT/US2019/037965

§ 371 Date: Dec. 8, 2020

Related U.S. Application Data
(60) Provisional application No. 62/687,577, filed on Jun. 20, 2018.

(51) Int. Cl. H04W 56/00; H04W 24/08; H04W 88/14

(52) U.S. Cl. CPC H04W 56/0015; H04W 88/14; H04W 24/08; H04W 56/0045

(57) ABSTRACT

The present application describes an apparatus on a network a non-transitory memory including instructions stored thereon for resynchronization. The apparatus also includes a processor operably coupled to the non-transitory memory configured to execute the instructions of performing downlink (DL) synchronization with an integrated and access backhaul (IAB) parent node. Synchronization includes searching for a synchronization signal/physical broadcast channel (SS/PBCH) of the parent IAB node distinct from other SS/PBCH signals of the parent IAB node assigned for user equipments (UEs). The processor is configured to execute the instructions of performing random access to obtain a timing advance (TA) from the parent IAB node, and receiving a timing adjustment (T_{adj}) from the parent IAB node for the resynchronization separate from the TA. Based on the T_{adj} and TA, the processor applies a timing alignment of DL transmissions for the UEs and child nodes and/or applies a timing alignment of uplink (UL) transmission to the parent IAB node.

### CROSS-REFERENCE TO RELATED APPLICATION

This application claims the benefit of priority of U.S. Provisional application No. 62/687,577 filed Jun. 20, 2018 entitled, “Synchronization in Multi-hop NR IAB Deployment” the contents of which is incorporated by reference in its entirety.

### FIELD

The present application is directed to mechanisms to enable synchronization of nodes in an IAB network through over-the-air (OTA) signaling.

### BACKGROUND

Due to the multi-hop nature of an integrated access and backhaul (IAB) deployment, an IAB node may need to transmit either to its own access UEs and other IAB nodes in hops below (e.g., on the downlink (DL)), or to other IAB nodes or IAB donors in a hop above (e.g., on the uplink (UL)). It is envisaged that synchronization between nodes will help resource utilization and keep cross-link interference under check.

Synchronization within an IAB network can result in synchronization between different transmission nodes and directions (i.e., DL or UL of access with DL or UL of backhaul) at an IAB node. It is therefore desired for new radio (NR) to define synchronization schemes and support mechanisms to apply an appropriate scheme for deployment.

When attempting to synchronize nodes across multiple hops, a child node and its immediate parent node may be synchronized. However, timing errors accumulated over multiple hops may result in a poorly synchronized network.

Further, new IAB nodes will need to be discovered and measured over time to support multiple links in order for certain links to serve as a backup. In addition, an IAB node not in sync with a given IAB node must still be discoverable and measured. What is desired in the field of NR is a means to improve discovery signals for backhaul IAB nodes.

### SUMMARY

This summary is provided to introduce a selection of concepts in a simplified form that are further described below in the Detailed Description. This Summary is not intended to limit the scope of the claimed subject matter. The foregoing needs are met, to a great extent, by the present application directed to

One aspect of the application describes an apparatus on a network a non-transitory memory including instructions stored thereon for resynchronization. The apparatus also includes a processor operably coupled to the non-transitory memory configured to execute the instructions of performing downlink (DL) synchronization with an integrated and access backhaul (IAB) parent node. Synchronization includes searching for a synchronization signal/physical broadcast channel (SS/PBCH) of the parent IAB node distinct from other SS/PBCH signals of the parent IAB node assigned for user equipment (UEs). The processor is configured to execute the instructions of performing random access to obtain a timing advance (TA) from the parent IAB node, and receiving a timing adjustment (T_{adj}) from the parent IAB node for the resynchronization separate from the TA. Based on the T_{adj} and TA, the processor applies a timing alignment of DL transmissions for the UEs and child nodes and/or applies a timing alignment of uplink (UL) transmission to the parent IAB node.

Another aspect of the application describes an apparatus on a network a non-transitory memory including instructions stored thereon for handling resynchronization in a multi-hop deployment. The apparatus also includes a processor operably coupled to the non-transitory memory configured to execute the instructions of monitoring a downlink (DL) transmission from a first parent node in the network. The processor is also configured to execute the instructions of obtaining, from the DL transmission, an indication of the resynchronization located in a first frame of the first parent node, and determining a timing advance to the first parent node (TAₚₐᵣₑₙₜ₁) on an uplink (UL) backhaul of the apparatus. The processor is further configured to execute the instructions of evaluating a timing advance to a second parent node (TAₚₐᵣₑₙₜ₂) on the network, determining a timing adjustment (T_{adj}) for the resynchronization; and sending the T_{adj} to a child node for resynchronization.

There has thus been outlined, rather broadly, certain embodiments of the invention in order that the detailed description thereof may be better understood, and in order that the present contribution to the art may be better appreciated.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1A illustrates an example communications system.

FIGS. 1B, 1C, and 1D are system diagrams of example RANs and core networks.

FIG. 1E illustrates another example communications system.

FIG. 1F is a block diagram of an example apparatus or device, such as a WTRU.

FIG. 1G is a block diagram of an exemplary computing system.

FIG. 2 illustrates an IAB deployment showing a parent, child and donor and access nodes.

FIG. 3 illustrates timing synchronization between IAB nodes for transmission to child nodes according to the application.

FIG. 4 illustrates timing synchronization reception between BH and access at the IAB node according to the application.

FIG. 5 illustrates synchronized transmission between BH and access at the IAB node according to the application.

FIG. 6 illustrates synchronized transmissions and synchronized reception at the IAB node according to the application.

FIG. 7 illustrates a gap when switching between BH and access according to the application.

FIG. 8 illustrates IAB node switching to a Parent₂ from Parent₁ and disrupting the synchronization according to the application.

FIG. 9 illustrates a technique for measuring the relative desynchronization between the parent using the DL-B frame boundary timing at the IAB node according to the application

FIGS. 10A-C illustrate applications of T_{adj} at the user equipment (UE) according to the application.

FIGS. 11A-B illustrate procedures at the UE for resynchronization on receiving T_{adj} DL resynchronization and UL resynchronization, respectively, according to the application.

FIG. 12 illustrates a technique for performing resynchronization using SS/PBCH within a synchronization period according to the application.

FIG. 13 illustrates UE procedures to resynchronize by acquiring the SS/PBCH timing within the measurement period according to the application.

FIG. 14 illustrates a location backhaul synchronization signal/backhaul physical broadcast channel (BH-SS/PBCH) in frequency between synchronization raster locations according to the application.

FIG. 15 illustrates a location of the synchronization signal (SS) burst in backhaul discovery measurement timing configuration (BHDMTC) according to the application.

FIG. 16 illustrates a location of the synchronization signal/physical broadcast channel (SS/PBCH) blocks within BHDMTC varying every period according to the application.

### DETAILED DESCRIPTION OF THE ILLUSTRATIVE EMBODIMENTS

A detailed description of the illustrative embodiment will be discussed in reference to various figures, embodiments and aspects herein. Although this description provides detailed examples of possible implementations, it should be understood that the details are intended to be examples and thus do not limit the scope of the application.

According to one aspect of the application, mechanisms and procedures to enable resynchronization of the access and child nodes when the timing changes with respect to the parent node. In one embodiment, the method indicates the need for resynchronization in a broadcast mode. In another embodiment, the method enables DL re-synchronization through SS/PBCH in a synchronization period.

Another aspect of the application is directed to methods that discover and synchronize with new IAB nodes.

### Definitions and Acronyms

Provided below are acronyms for terms and phrases commonly used in this application.

BH—Backhaul

BHDMTC—Backhaul Discovery Measurement timing configuration

BH-PBCH—Backhaul Physical Broadcast Channel

BH-SS/PBCH—BackHaul Synchronization Signal/Backhaul Physical Broadcast Channel

CLI—Cross link Interference

C-RNTI—Cell Radio-Network Temporary Identifier

DL—Downlink

DRS—Discovery Reference Signal

eMBB—enhanced Mobile Broadband

eNB—Evolved Node B

FDD—Frequency Division Duplex

FR1—Frequency region 1 (sub 6 GHz)

FR2—Frequency region 2 (mmWave)

gNB—NR NodeB

HARQ—Hybrid ARQ

IAB—Integrated Access and Backhaul

MAC—Medium Access Control

MIB—Master Information Block

NR—New Radio

OFDM—Orthogonal Frequency Division Multiplexing

OTA—Over the Air

PCell—Primary Cell

PHY—Physical Layer

RAN—Radio Access Network

RAT—Radio Access Technology

RMSI—Remaining System information

RRC—Radio Resource Control

SCell—Secondary Cell

SI—System Information

SIB—System Information Block

SS—Synchronization Signal

SSB—SS Block

SS/PBCH—Synchronization signal/Physical broadcast channel

TA—Timing advance

TDD—Time Division Duplex

TRP—Transmission and Reception Point

TTI—Transmission Time Interval

UE—User Equipment

UL—Uplink

### General Architecture

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

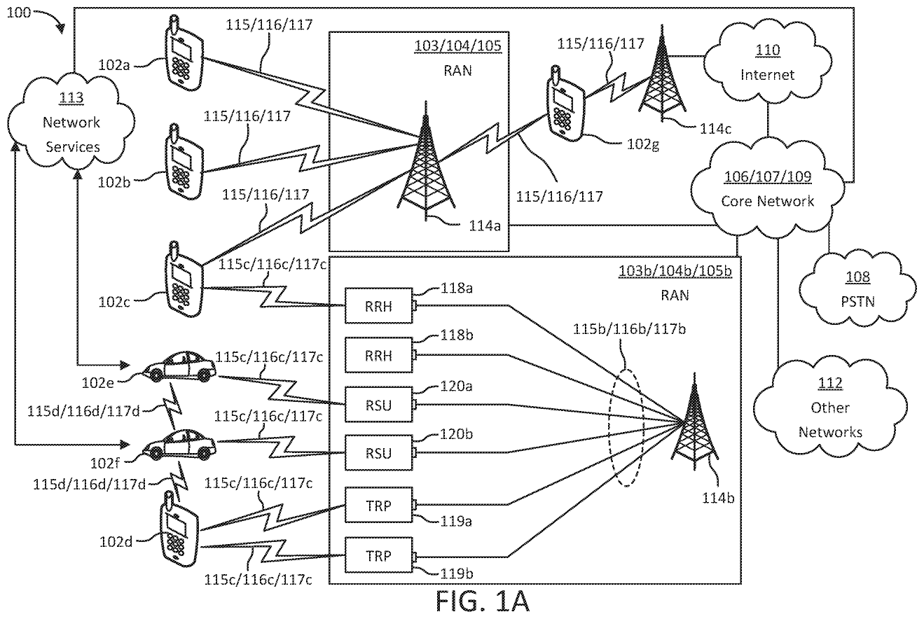

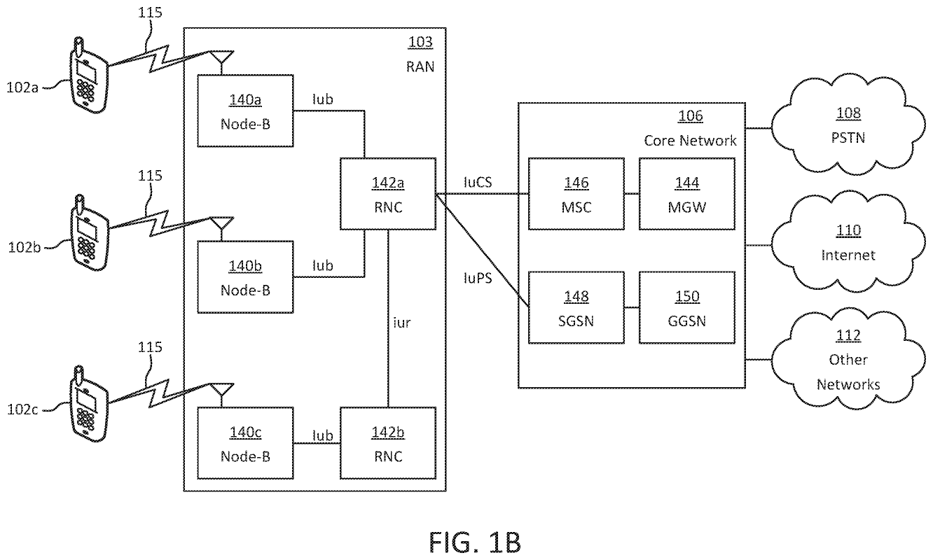

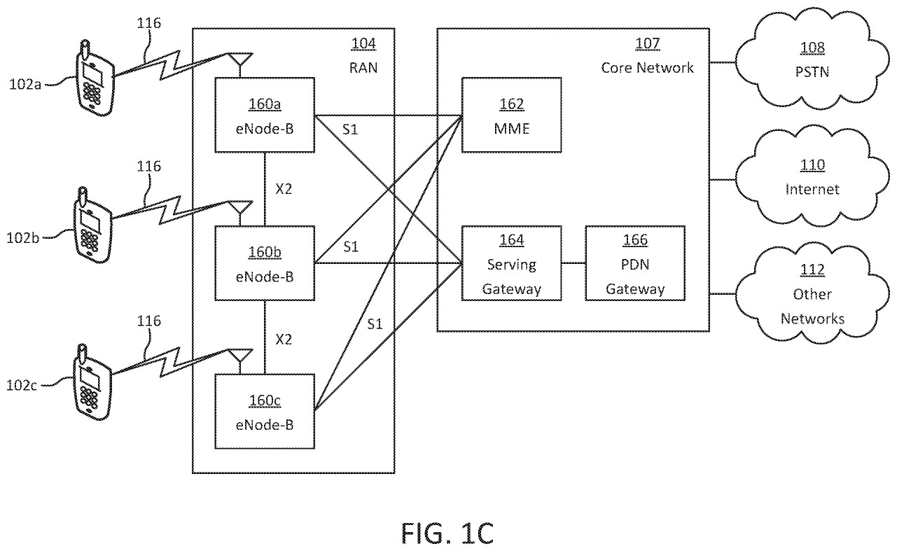

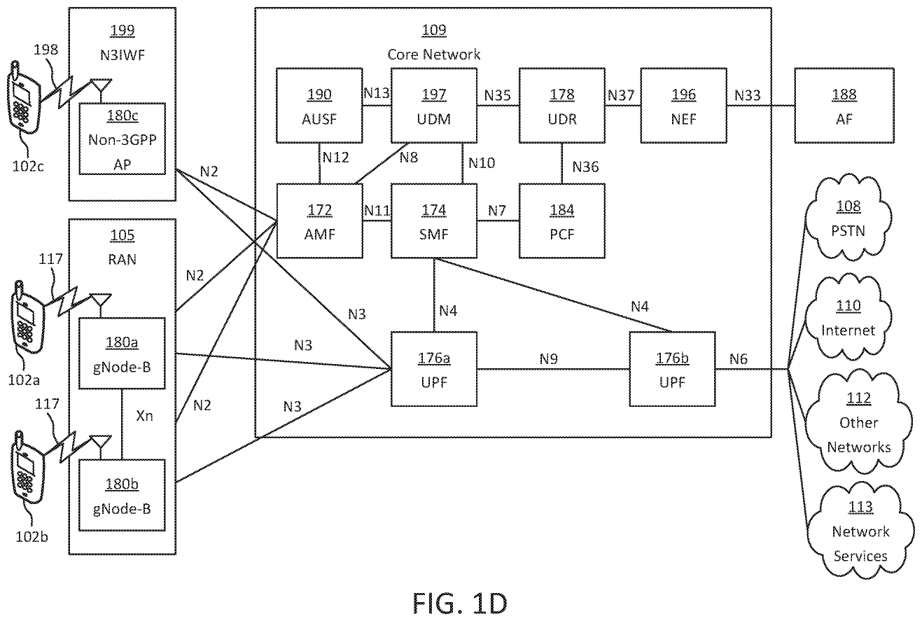

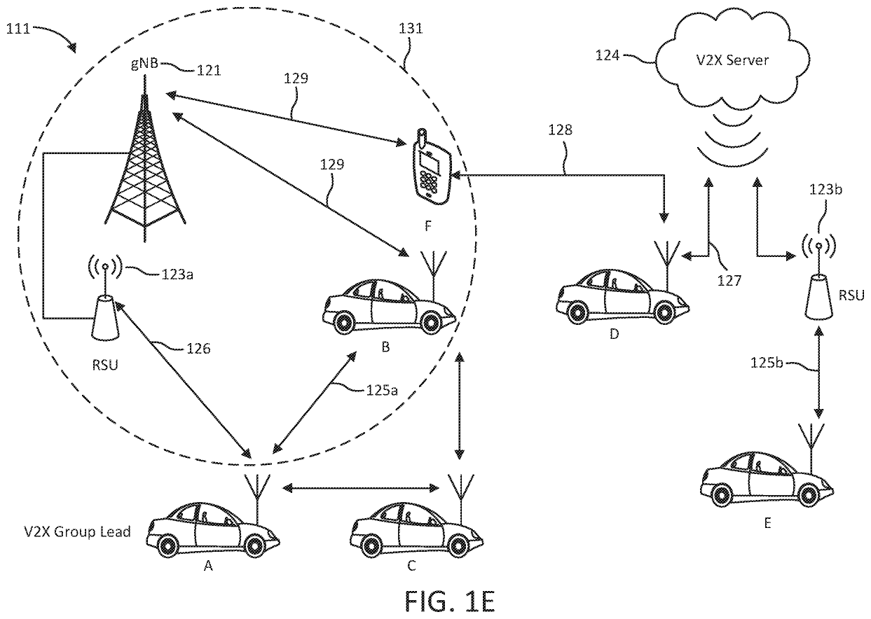

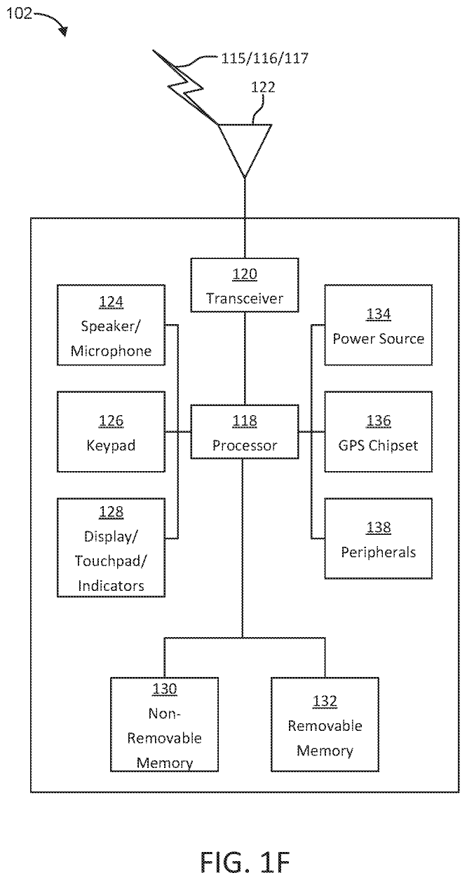

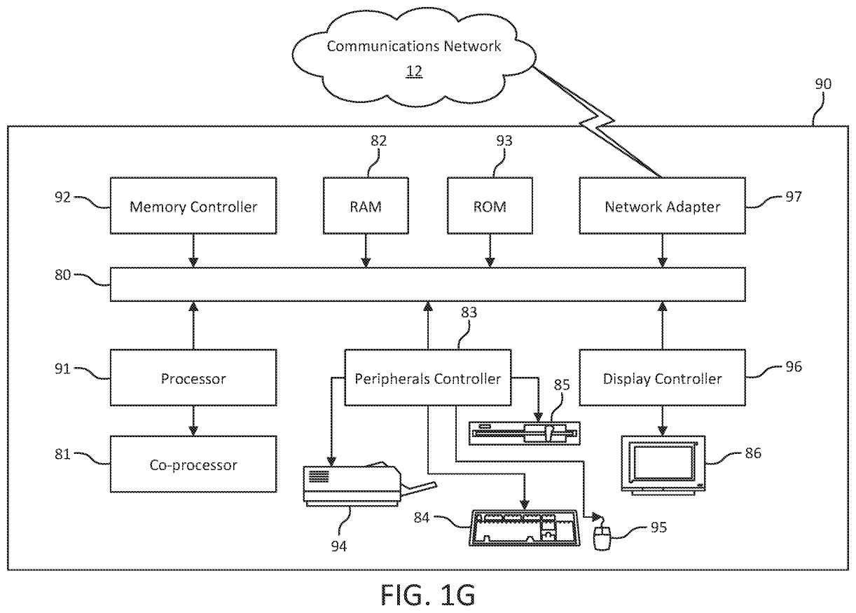

FIG. 1A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment.

In the example of FIG. 1A, each of the WTRUs 102 is depicted in FIGS. 1A-1E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 1A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multi pie-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 1A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 1A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 1A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 1A may be configured to communicate with the base station 114a, which may employ a cellular-based radio technology, and with the base station 114c, which may employ an IEEE 802 radio technology.

Although not shown in FIG. 1A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 1B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 1B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 1B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 1B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 1C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 1C, the eNode-Bs 160a, 160b, and 160c may communicate with one another over an X2 interface.

The core network 107 shown in FIG. 1C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 1D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 1D, the gNode-Bs 180a and 180b may communicate with one another over an Xn interface, for example.

The core network 109 shown in FIG. 1D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in Figure x1G.

In the example of FIG. 1D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 1D shows that network functions directly connect to one another, however, it should be appreciated that they may communicate via routing agents such as a diameter routing agent or message buses.

In the example of FIG. 1D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 1D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 1D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 1D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 1A, 1C, 1D, and 1E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 1A, 1B, 1C, 1D, and 1E are provided by way of example only, and it is understood that the subject matter disclosed and claimed herein may be embodied or implemented in any similar communication system, whether presently defined or defined in the future.

FIG. 1E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 1E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 1E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 1F is a block diagram of an example apparatus or device WTRU 102 that may be configured for wireless communications and operations in accordance with the systems, methods, and apparatuses described herein, such as a WTRU 102 of FIG. 1A, 1B, 1C, 1D, or 1E. As shown in FIG. 1F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 1F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 1A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 1F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 1G is a block diagram of an exemplary computing system 90 in which one or more apparatuses of the communications networks illustrated in FIGS. 1A, 1C, 1D and 1E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 1A, 1B, 1C, 1D, and 1E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

### Terminology for the IAB Network

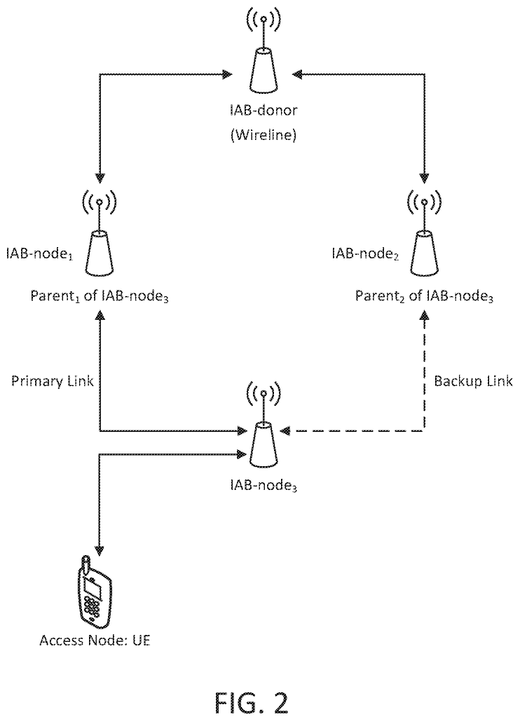

As illustrated in FIG. 2, the different components of the IAB network include the following.

IAB donor: A RAN-node that provides UE's interface to core network and wireless backhauling functionality to IAB nodes.

IAB node. A RAN-node that provides IAB functionality, i.e., access for UEs combined with wireless self-backhauling capabilities. An IAB node may have two roles as follows:

The UEs and other IAB nodes that are under control of an IAB node are called child nodes;

The donor or another IAB node that controls and schedules the IAB node is called its parent node.

An IAB node may maintain links with multiple parents so that it has some backup links if the primary link fails.

### OTA Synchronization of IAB Nodes

A global navigation satellite systems (GNSS) provides high accuracy absolute timing (e.g., in the order of 100 ns). For cases that need to share a common frame timing between RNs, additional signaling is needed for GNSS based synchronization. Alternatively, OTA synchronization can be used to achieve synchronization among RNs and share a common frame timing. Alignment at symbol boundary or other granularities of timing such as slot boundary may also be achieved through GNSS or OTA signaling.

An IAB node can synchronize to its parent node(s) using the available synchronization mechanism of the UE interface (i.e., tracking downlink receive timing, performing RACH procedure for obtaining Timing Advance (TA) and adjusting uplink transmit timing using the provided TA command). This would naturally synchronize the whole network to the IAB-donors.

3GPP NR study item has agreed that IAB should support Timing advance (TA)-based synchronization between IAB nodes, including across multiple backhaul hops. The study is also considering enhancements to existing mechanisms for TA-based synchronization. The study will evaluate the following:

Case 1: DL transmission timing alignment across IAB nodes and donor nodes.

Case 2: DL and UL transmission timing is aligned within an IAB node.

Case 3: DL and UL reception timing is aligned within an IAB node.

Case 4: within an IAB node, when transmitting using Case 2 and when receiving using case 3.

Case 5: Case 1 for access link timing and Case 4 for backhaul link timing within an IAB node in different time slots.

The study will also study the following levels of alignment between IAB nodes/donor nodes or within an IAB node: slot alignment; symbol-level alignment; and no alignment.

Discovery and Measurement of IAB nodes

New nodes may be added or existing nodes may be removed from a network. Multi-hop connection topology may also change over time. To manage the topology, discovering new nodes and measuring existing ones is required.

The 3GPP NR Study Item has agreed to support detection and measurement of candidate backhaul links (after initial access) which utilizes resources that are orthogonal in time from those used by access UEs for cell detection and measurement. The study has agreed to consider the following designs for indicating the discovery/measurement signals.

TDM of SSBs (e.g., depending on hop order, cell ID, etc.);

SSB muting across IAB nodes;

Multiplexing of SSBs for access UEs and IABs within a half-frame or across half-frames;

Additional IAB node discovery signal TDM with SSB (e.g., CSI-RS);

Use of off-raster SSBs;

Different transmission periodicity compared to the periodicity used by access UEs, and

Coordinating mechanisms for different solutions;

### Timing Configuration

Timing synchronization between IAB nodes can be defined in different ways. In this patent application, the following notations will be employed;

DL-B: DL Backhaul

UL-B: UL Backhaul

DL-A: DL Access

UL-A: UL Access

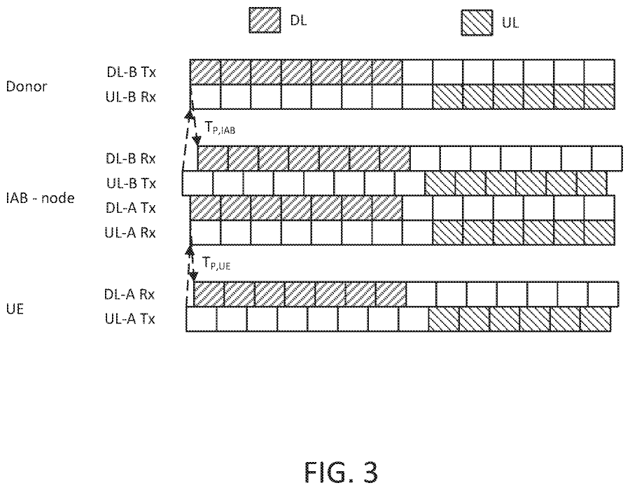

According to one aspect of the application, if the IAB node is synchronized to its parent node, the relative synchronization of the access frames to the BH frames may be obtained. This is exemplarily shown in the synchronization scheme embodiments in FIGS. 3-6. The figures show slot timing at a donor, IAB node and an access UE connected to the IAB node. The term T_{P,IAB} refers to the propagation delay between the IAB node and its parent, which could be a donor node while the term T_{P,UE} refers to the propagation delay between the access UE and its parent IAB node.

FIG. 3 depicts Scheme-1 for synchronization according to one embodiment of this aspect.

The DL-A and UL-A timing are synchronized with the parent so the nodes in the network are synchronized to the same timing reference. This may result in less cross-link-interference (CLI) in the system. The DL-A transmission and UL-A reception at the IAB node are offset by T_{P,IAB} relative to the DL-B reception timing to synchronize to the Donor. This also implies the DL-B and UL-A reception at the IAB node may not be time-aligned. Similarly, UL-B and DL-A transmission at the IAB node are not time aligned. This may cause inefficiency when sharing resources between access and BH.

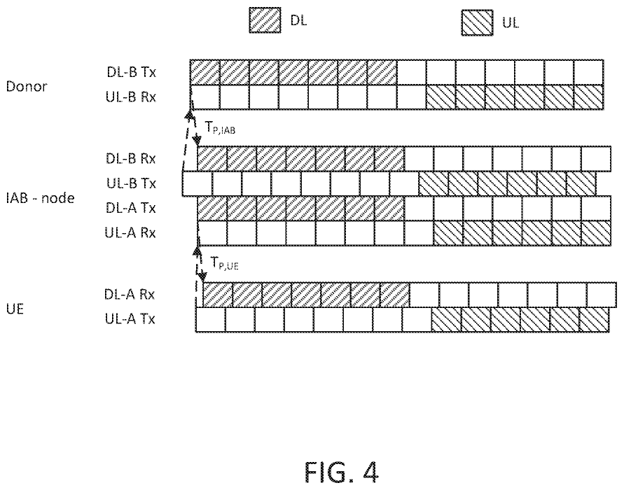

FIG. 4 depicts Scheme-2 according to another embodiment of this aspect. Here, DL-B and UL-A reception at the IAB node are time-synchronized so that the resources can be shared between BH and access. However, the UL-B and DL-A transmissions are not time aligned. Moreover, the nodes in the network are not synchronized to one reference timing.

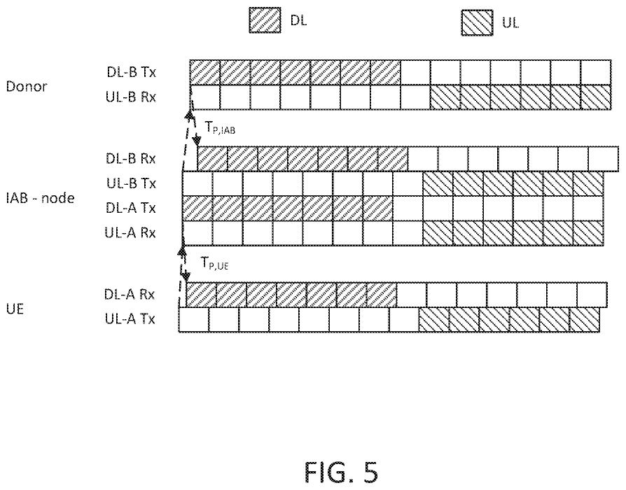

FIG. 5 depicts Scheme-3 according to another embodiment of this aspect. Here. UL-B and DL-A transmission at the IAB node are time-synchronized so that the resources can be shared between BH and access. However, the DL-B and UL-A reception are not time aligned. Moreover, the nodes in the network are not synchronized to one reference timing.

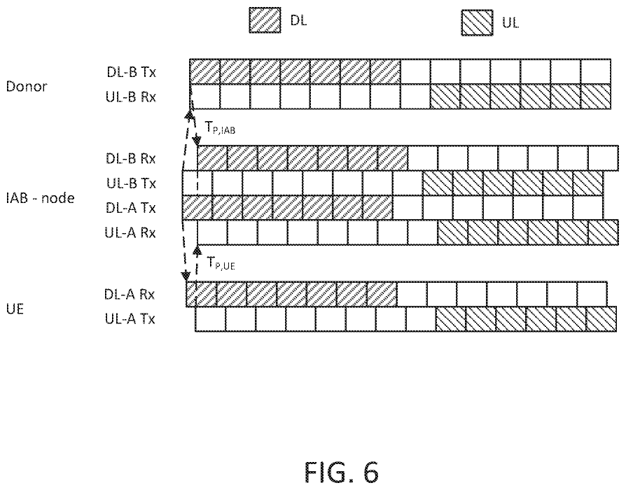

FIG. 6 depicts Scheme-4 according to yet another embodiment of this aspect. Here, DL-B and UL-A reception at the IAB node are time-synchronized. UL-B and DL-A transmissions at the IAB node are synchronized. The nodes in the network are not synchronized to a common reference timing.

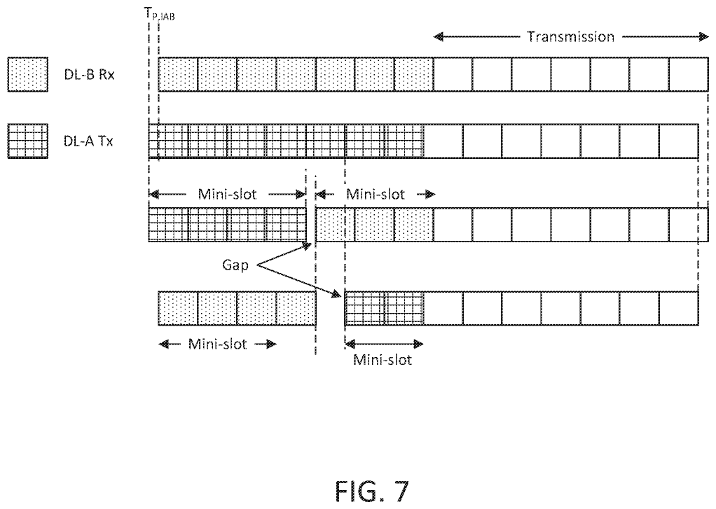

According to another embodiment, a guard period (GP) or gap in time is required for switching from a BH to access transmission and vice-versa. FIG. 7 shows the DL-B and DL-A reception for Scheme-1 in FIG. 3. Switching from DL-B reception to DL-A transmission requires a gap of T_{P,IAB} due to the misalignment between the symbol boundaries of the DL-B and DL-A at the IAB node.

Each scheme requires a different gap at the IAB node to switch between different transmissions and reception. Large gaps are not desired since they result in poor resource utilization in the network. The different schemes described above offer benefits under different conditions such as propagation delay, resource utilization. Therefore, the application envisages different options in different deployments. The application also envisages switching between schemes.

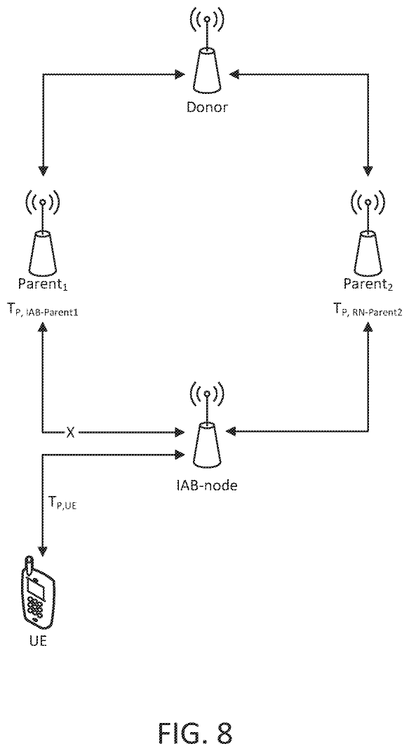

In a further embodiment, a new parent in a BH link may employ a different scheme from that of the target IAB node. If the target IAB node becomes a child of a new parent, it may have to switch to the new parent's scheme. As shown in FIG. 8, the propagation delays T_{P,IAB-Parent1} and T_{P,IAB-Parent2} to Parent₁ and Parent₂ respectively, can be different and can affect the timing at IAB node. This can occur if the IAB node detaches from the current parent and attaches to a new parent due to a change in the topology. This is more likely to occur in dense small cell deployment in FR2 where a link may consist of several hops (possibly 5-10) and parent nodes may appear or drop out of the network depending on the traffic conditions or blockage. If so, the IAB node may need to resynchronize to the UL-B or DL-B. In turn, this may trigger resynchronization of DL-A or UL-A timings for accessing UEs and child nodes of the IAB node.

Even for the case with a single parent, it may be beneficial to support different synchronization schemes. When switching between two schemes, the timing will need to be adjusted. So, the IAB node may need to resynchronize to the new scheme and adjust its timing on the DL-A, UL-A or both.

Transmission of Resynchronization Information from IAB Node to UEs and Child Nodes

Another aspect of the application describes transmission of resynchronization information from an IAB node to UEs and child nodes. In this aspect, The TA of an IAB node to Parent₁ is denoted as TA_{Parent1}. The timing advance on the UL-B for the IAB node is TAₚₐᵣₑₙₜ₁=2·T_{P,IAB-Parent1}. In one embodiment of this aspect, if the IAB node attaches to Parent₂, it may detach from Parent₁ or maintain connectivity to both parents. In another embodiment, when the IAB node must synchronize to Parent₂, it may need to adjust its access nodes' timing so that routing can occur through Parent₂.

The IAB node can obtain the estimate of the timing advance to Parent₂, TA_{Parent2}=2·T_{P,RN-Parent2} through one of the following operations described below. In a first operation, the IAB node performs Initial Access (IA) via PRACH with Parent₂ and obtains TA prior to relinquishing the path through Parent₁. This ensures minimal disruption in communication for the access links. Therefore, Parent₂ provides the value TA_{Parent2} to the IAB node with the response of the PRACH.

In a second operation, if Parent₁ and Parent₂ are connected to a donor, the donor may coordinate resynchronization and estimate the T_{P,RN-parent2} and may provide this information to the UE through Parent₁.

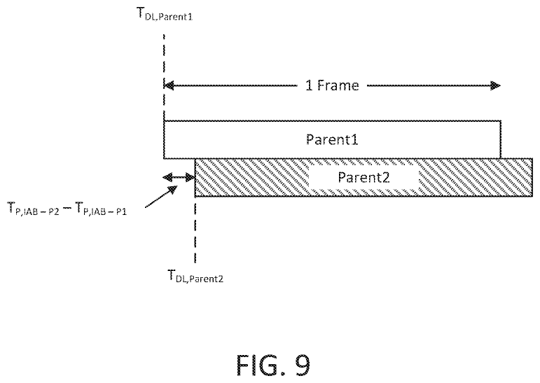

In a third operation, the IAB node obtains only DL synchronization with Parent₂ prior to relinquishing the path through Parent₁. The IAB node may estimate its propagation time to Parent₂ as T_{P,IAB-Parent2}=T_{P,IAB-Parent1}+(t_{DL,Parent2}−t_{DL,Parent1}) and its TA with Parent₂ as TA_{Parent2}=2·T_{P,IAB-Parent2}. Here, t_{DL,Parent2} is the observed frame time for Parent on the DL and t_{DL,Parent1} is the observed frame time for Parent₁. The difference between (t_{DL,Parent2}−t_{DL,Parent1}) gives the relative timing misalignment of the observed DL signals at the UE. This can be assumed to be a result of the relative propagation time difference to the parents. In an exemplary embodiment, FIG. 9 shows the relative difference between frame boundaries of Parent₁ and Parent₂ for the IAB node on DL-B. Alternatively, the relative difference between subframe boundaries may be used for synchronization. If the network has OTA synchronization, the relative timing misalignment is small and may be measured to be the same when using frame boundaries or subframe boundaries as a reference. The above-mentioned principles may also apply to synchronizing using finer granularity such as subframe or slot or symbol boundaries. Therefore, while many example below refer to frame boundary synchronization, the principles may be applied to subframe, slot and symbol boundary synchronization.

In an example, the required timing adjustment to resynchronize is given by T_{Adj}=(T_{P,IAB-Parent2}−T_{P,IAB-Parent1}) The TA to Parent₂ on the IAB node's UL-B is TA_{Parent2}=TAₚₐᵣₑₙₜ₁+2·T_{Adj}. Re-synchronization may also be required if the synchronization scheme (i.e., FIGS. 3-6) is switched and one or more timing references is changed. For example, if the synchronization scheme is changed from Scheme-1 (FIG. 3) to Scheme-3 (FIG. 4), the DL-A and UL-A timing have to change. It is assumed T_{Adj} is the correction to be indicated to the access and child nodes in this case as well. T_{Adj} may be transmitted periodically or aperiodically so that the access and child nodes can resynchronize.

In one embodiment, the IAB node may provide timing adjustment T_{Adj} to access UEs and child nodes so that they can resynchronize due to a change in topology of the synchronization scheme. T_{Adj} may be transmitted prior to making the timing adjustment on the access link. In addition to T_{adj}, the IAB node may transmit one or more of the following information to child and access nodes.

T_{mod}: the time when the adjustment is applied to the access link

T_{ref}: the reference time with respect to which T_{mod} is indicated

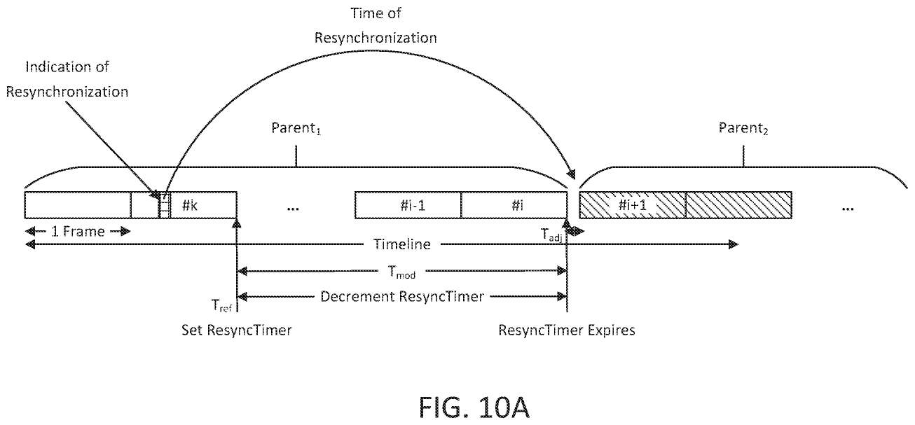

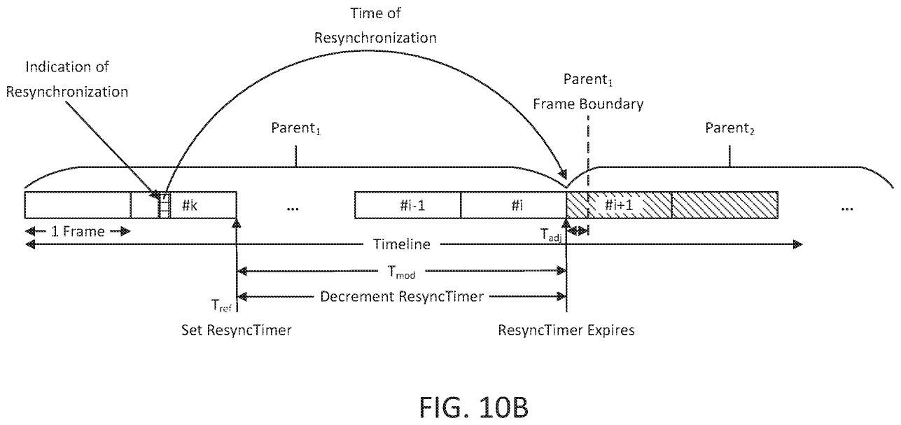

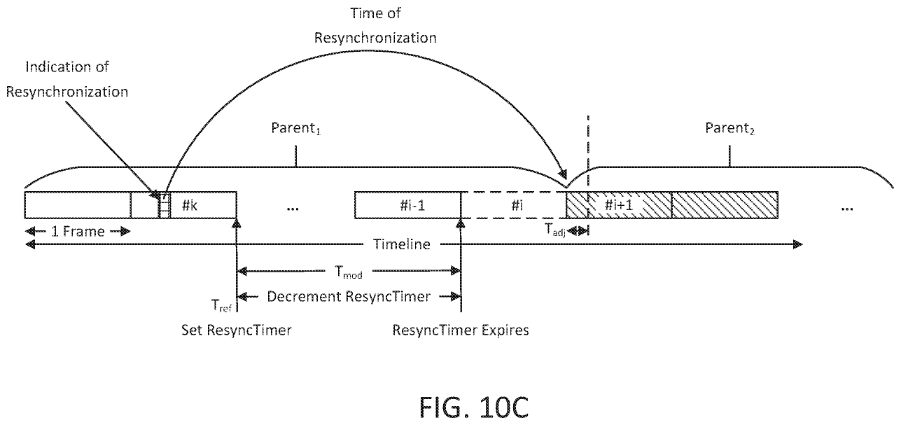

For example, T_{Adj} may be applied at a frame boundary as shown in FIGS. 10A-C. T_{mod} may be signaled as the SFN value when the re-synchronization is done. Alternatively, it may be signaled as an offset in the frame number from the frame in which the resynchronization index occurs.

The UE may run a resyncTimer to count down the period of T_{mod}. Then, the adjustment T_{adj} applied by the UE to adjust its timing. The UE sets the timer when it receives the indication for resynchronization, for example, from the start of the frame following the frame carrying the indication. When the resyncTimer has not expired, the UE may communicate with Parent₁ after which it does not monitor DL or UL using the timing of Parent₁. Subsequently, it adjusts it timing with reference to Parent₂ using T_{Adj}. If the UE supports multiple links to different parent IAB nodes (i.e., may be through dual connectivity), the UE maintains separate resyncTimers to synchronize with each parent or the UE maintains a resyncTimersGroup for a group of IAB node candidates.

The embodiments in FIGS. 10A-C show how T_{adj} is applied in the DL of the UE. Frame numbering is from the perspective of the UE. In FIG. 10A, if T_{adj} is a positive value, a gap occurs between the frame timing with Parent₁ and frame timing with Parent₂. The indication to resynchronize comes in frame #k. The UE may assume it can communicate with Parent₁ (for d≥0) for up to frame #(i-d). In FIG. 10A (for d=0) after applying the T_{adj} Correction, the UE begins communication with Parent₂ from frame #i+m, where m>=1. In FIG. 10A, when m=1, the UE does not monitor DL or transmit UL for either parent in the gap. Frame numbering is from the perspective of the UE.

Alternatively, one of the following exemplary procedures may be used if T_{adj} is a negative value. Specifically, for Frame #i+1, Parent advances into the frame duration of Frame #i from Parent₁ since T_{adj} is negative.

In the procedure shown in FIG. 10B, the UE applies T_{adj} Correction and synchronizes with Parent at the start of frame #i+1. The UE may maintain communication with Parent₁ so long as the resyncTimer has not expired. This allows resynchronization to occur with minimal latency.

In the procedure shown in FIG. 10C, where m>=1, the UE assumes a gap between Frame #i−1 to communicate with Parent₁. Moreover, Frame #i+m communicates with Parent2. When m=1, the UE communicates with Parent₁ up to frame #i−1, and with Parent from frame #i+1. The duration between frame #i−1 and frame #i+1 at the UE is a gap. The UE does not monitor DL or transmit UL on either parent in the gap.

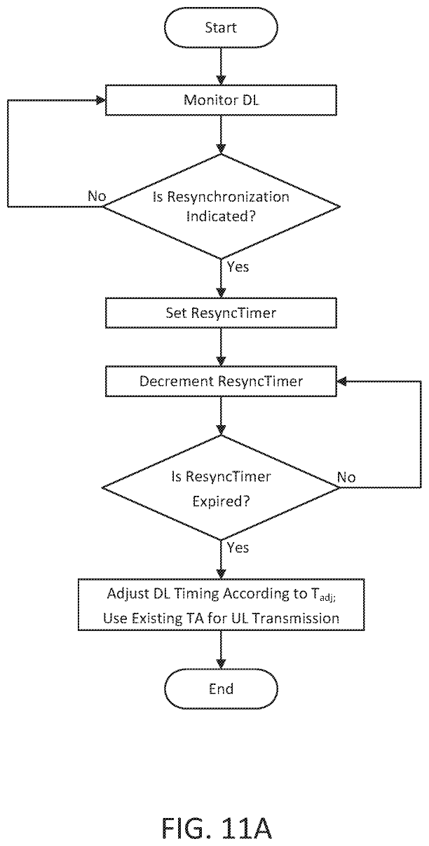

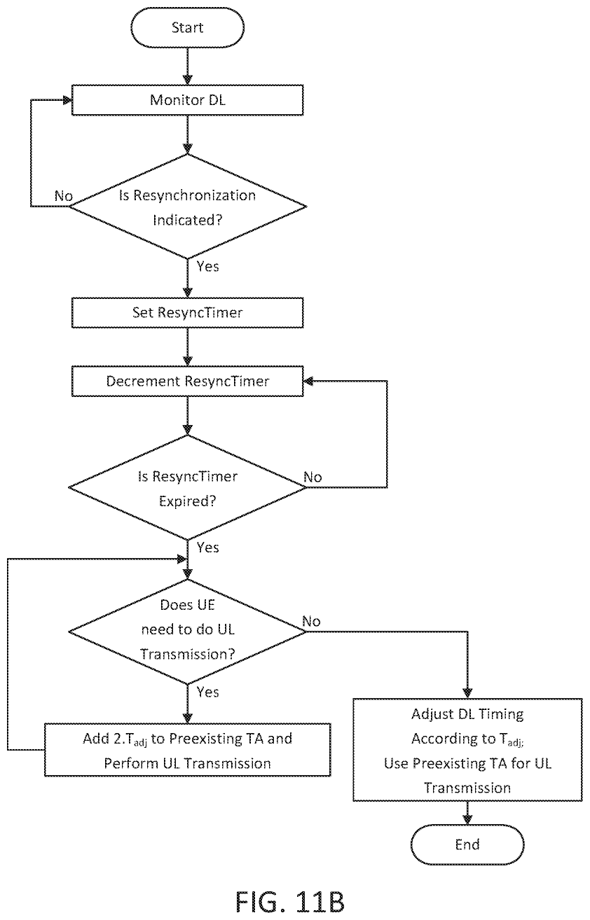

According to another embodiment, the UE and child node perform one of the following procedures upon receiving T_{adj}. In one procedure as shown in FIG. 11A, the timing is adjusted for DL reception by T_{adj} (i.e., frame timing is adjusted by T_{adj}). If DL resynchronization is complete, the UE's clock is adjusted to the new timing based on the DL. The TA remains the same for the UE as the UE's propagation time to the IAB node has not changed (i.e., the TA does not change after resynchronization). The same TA is applied with respect to the DL frame boundary after DL resynchronization. In other words, the adjusted timing is separately signaled from the timing advance and applied as an offset to the UE's existing DL timing which is the time gap between UL transmission timing and DL reception timing

Another procedure as shown in FIG. 11B. Here, if DL re-synchronization is complete, but the UE needs to perform UL synchronization, the receiver uses an adjusted timing advance (TA) TA_{Parent2}=TA_{Parent1}+2·T_{adj} for UL transmission.

Synchronization Period for Resynchronization

Another aspect of the application describes a synchronization period for resynchronization. Specifically, if the timing changes for DL-A transmission from the IAB node, either due to change in the synchronization scheme or change in topology, the IAB node may provide a “synchronization period” to the access nodes for resynchronization. The synchronization period may referred to as a “self-measurement gap.” This is due to the UE attempting to synchronize with the SS/PBCH block of its own cell (i.e., UE's parent IAB node), but does not perform reception of other DL signals or UL transmission during the gap. In other words, the UE resynchronizes within its own cell, typically correcting relatively large timing error conceivably multiple samples at its sampling rate. This is in comparison to when the UE performs fine synchronization correcting a fraction of a sample at the sampling rate during normal SS/PBCH monitoring.

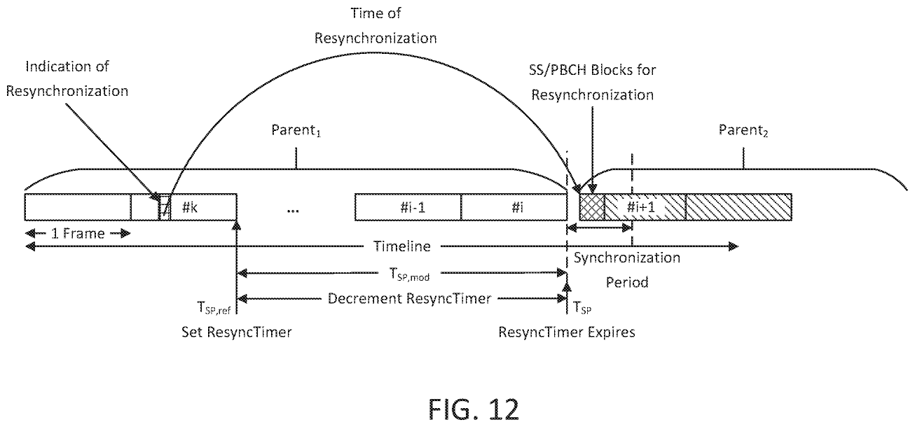

The concept of the synchronization period is exemplarily illustrated in FIG. 12. The IAB node indicates a synchronization period T_{SP} in the future. Within this period, the UE should resynchronize with the SS/PBCH block and obtain the new timing. In addition, the IAB node may indicate the following parameters:

T_{SP mod}: the time of start of the synchronization period

T_{SP ref}: the reference time with respect to which T_{SP mod} is applied

These parameters may be indicated as a function of the SFN (i.e., the T_{SP} period begins after SFN #i which uses the original timing). Alternatively, it may be signaled as an offset in the frame number from the frame in which the resynchronization index occurs.

During the synchronization period, the UE only monitors the SS/PBCH of its cell and acquires the DL timing. After the synchronization period ends, the UE starts monitoring DL and transmitting on UL as scheduled or configured.

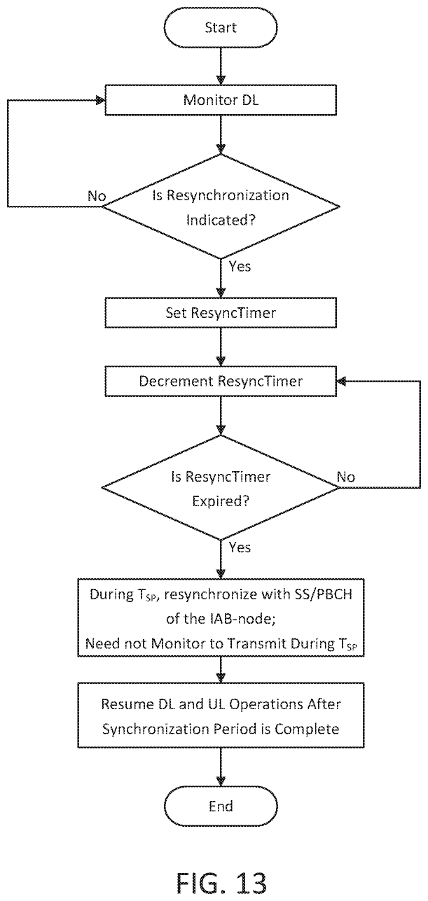

The procedure for resynchronization is exemplarily shown in FIG. 13. Namely, the UE uses a resync timer set on receiving the indication to resynchronize. The UE decrements the timer and on expiry stops DL and UL operations using the existing synchronization timing. It enters the measurement gap and looks for SS/PBCH block to provide the new timing for DL synchronization. Upon completion of the synchronization period, it resumes DL and UL transmission using the new timing based on the SS/PBCH block. Generally, switching may seamlessly be done so the UE can process configured and scheduled grants after the synchronization period without disruption. These grants may have been provided to the UE prior to resynchronization. Similarly, HARQ retransmissions, A/N feedback in the resynchronized resources may proceed normally post-resynchronization.

### Indication of the Resynchronization Parameters

A further aspect of the application describes an indication of the resynchronization parameters. Specifically, the IAB node may transmit T_{adj} or T_{SP} and the related parameters through SI or DCI.

In one embodiment when transmitted through SI, resynchronization influences all the UEs and child nodes in the same way. The IAB node transmits T_{adj} in a broadcast manner. For example, the RMSI or OSI may carry the T_{adj} and related parameters. As the T_{mod} value can be large (i.e., typically several 10s of ms), the UEs and child nodes have enough time to read the RMSI/OSI and prepare for the timing adjustment.

In another embodiment when transmitted through DCI, the parameters indicated through DCI that may be broadcast, multicast or UE-specific. In broadcast DCI, the DCI is scrambled by SYNC-RNTI and transmitted in a search space such as Type0-PDCCH or Type0A-PDCCH or Type2-PDCCH. The DCI indicates a PDSCH carrying information on T_{adj} or T_{SP} along with related parameters such as when the adjustment applies. In a group-common PDCCH, a DCI scrambled by SYNC-RNTI configures resynchronization for connected UEs. The DCI payload includes the parameters.

In another embodiment, a UE-specific DCI may be used, where, the UE-specific DCI is scrambled by C-RNTI or a child-specific DCI may be use, where, a specific RNTI associated with a child node and may be used to indicate T_{adj} or T_{SP} along related parameters to the UE.

Alternatively, a MAC CE in a PDSCH indicates the resynchronization information.

In another embodiment, a group-common adjustment may be multicast only to the child IAB nodes whereas the adjustment may be applied separately to the access nodes. For example, a SYNC-RNTI may provide the T_{adj} to the child nodes whereas any timing correction for access nodes is lumped with the TA and signaled to the UEs.

Some parameters may be indicated through DCI but other parameters may be configured through SI. T_{ref}, or T_{SP ref} may be configured through SI as it could be a relatively static value.

In the examples discussed so far, if the adjustment of timing results in net negative timing, the node may attempt resynchronization by resynchronizing with the SSBs of the parent and restart the RACH process to acquire an new timing advance.

The T_{adj} and timing advance may be indicated in the same DCI or in separate DCIs. The periodicity of indication of T_{adj} and timing advance may be different depending on the application. For example, T_{adj} may be relatively constant while the timing advance may be updated periodically. Alternatively, if many nodes join and leave the network, T_{adj} may vary more often; so T_{adj} may be indicated more frequently than the timing advance. The PDCCH order may provide T_{adj}.

Synchronizing with a New IAB Node

Synchronizing with a new IAB node is described in accordance with a further aspect of the patent application. Specifically, techniques are described on how an IAB node may synchronize with a new, potential parent node. The synchronization signal signaled for BH node discovery is referred to as BH-SS/PBCH. The signaling for accessing UEs may be in the form of a synchronization or discovery signal including SS/PBCH. SS/PBCH is used to refer to BH discovery or synchronization as BH-SS/PBCH. A given IAB node may signal its BH-SS/PBCH in a way that other IABs can receive the BH-SS/PBCH on their UL and discover notwithstanding having different frame structures from the given IAB node.

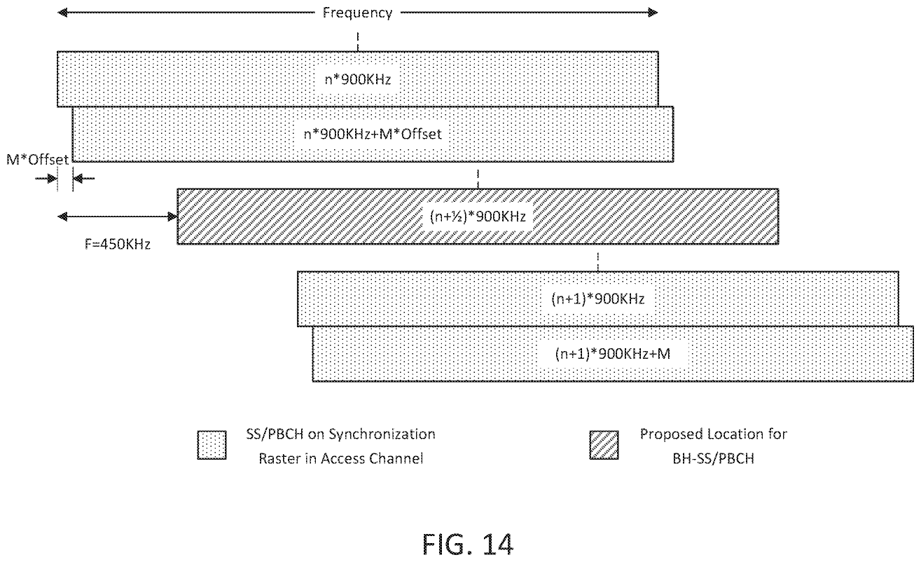

BH-SS/PBCH may be signaled in the following ways by the IAB nodes as described below. In one embodiment as shown in FIG. 14 for a frequency range below 2.4 GHz in FR1, the BH-SS/PBCH is signaled at an offset of F Hz from the sync raster so that UEs do not mistakenly lock to BH-SS/PBCH. The value of F is such that the BH-SS/PBCH does not fall on the sync raster. Here, F is ½ of the frequency separation between adjacent points in the synchronization raster. F may be defined by a set of possible values over which the IAB node must blindly detect the BH-SS/PBCH. The value of F may be restricted so that the SS/PBCH block is aligned with the PRBs boundary of the IAB node and a floating BH-SS/PBCH is avoided. This eliminates the need for the ssb-SubcarrierOffset bits (4-bit length) indication in the corresponding BH-PBCH. BH-PBCH may use the same payload size as access PBCH, and may reuse these bits to indicate other information such as traffic load, hop-number, and can allow a node to determine it should route through this IAB node.

Also, F may be signaled as an offset from a synchronization raster location with a fixed value for M. For the access link, M indicates the actual raster location, which may be an offset from the 100 KHz raster in FR1 and is indicated to the UE through the RMSI in the access link. By fixing the reference value for M, the possible values for F is limited so that blind detection becomes simpler and no indication is required through BH-RMSI (Backhaul RMSI).

In another embodiment, BH-SS/PBCH are indicated on the synchronization raster and orthogonal in time to the SS/PBCH of access signal. Additional information in the PBCH indicates that this information is for BH nodes. A UE that that synchronizes with the BH-SS/PBCH will treat it as an invalid synchronization. The UE will attempt to find the access SS/PBCH signals. In this case, the BH-RMSI of BH-SS/PBCH indicates the raster location of cell-defining SS/PBCH to the UE. The UE can directly access the correct raster location without additional latency in cell search.

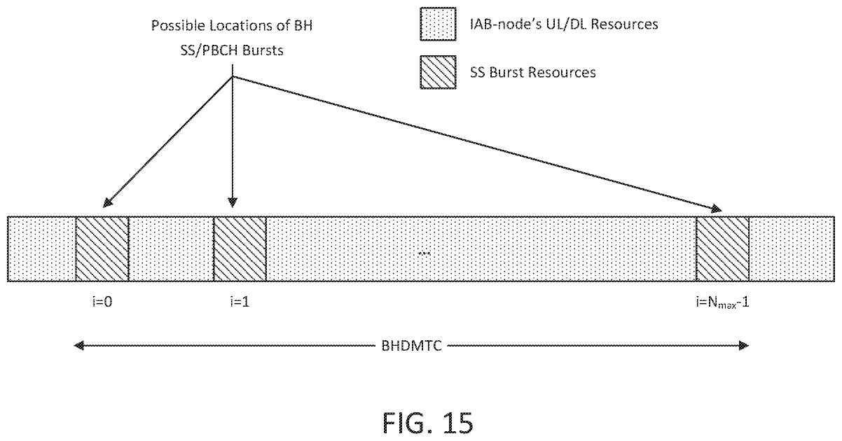

In yet another embodiment as shown in FIG. 15, with respect to the timing resources of the BH-SS/PBCH, these may be transmitted in certain locations within a window of time referred to as “BH discovery measurement timing configuration” (BHDMTC). BHDMTC's periodicity P_{BHDMTC} may be RRC configurable and set to a large value (i.e., typically in 10s or 100s of ms. The BH-SS/PBCH has Nₘₐₓ possible locations with the BHDMTC and the BHSSBLocᵢ refers to the index of the i^{th} possible location within the BHDMTC. The signal in BHSSBLocᵢ contains some or all the beams of the BH-SS/PBCH.

The BH-SS/PBCH is transmitted within the BHDMTC in one of the following ways. In one way, the index i in BHSSBLocᵢ is selected pseudo-randomly within the BHDMTC. The pseudo random pattern may be a function of the following: Cell ID; SFN; and Slot index within the SFN.

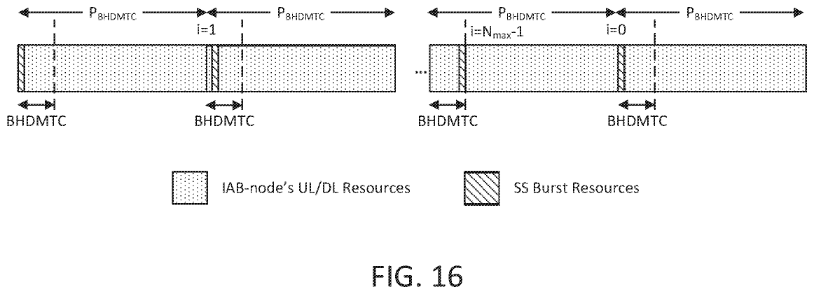

In another way, the index i in BHSSBLocᵢ is selected in a predetermined manner. For example, i is incremented by 1 in each period. When the index exceeds the largest possible value, the index is set to 0. The SS burst cycles through every possible location within the BHDMTC as exemplarily shown in FIG. 16. The PBCH of BH-SS/PBCH indicates the SFN. Although i may change in every period, the signaling may be designed such that no explicit indication of the frame timing is required. The index of the location of the discovered BH-SS/PBCH can be used along with the cell ID and SFN information to detect the frame boundary.

The relative offset of this frame timing may be used to determine the resynchronization required to attach to the discovered node. The configuration of the BH-SS/PBCH is be provided to the UE through RMSI/OSI or UE-specific RRC signaling, i.e., F, BHDMTC duration, P_{BHDMTC}, Nₘₐₓ and BWSSBᵢ carrying the BH-SS/PBCH are available to the UE. The UE does not monitor DL or transmit on the UL in the duration of the index carrying the BH-SS/PBCH.

According to the present disclosure, it is understood that any or all of the systems, methods and processes described herein may be embodied in the form of computer executable instructions, e.g., program code, stored on a computer-readable storage medium which instructions, when executed by a machine, such as a computer, server, M2M terminal device, M2M gateway device, transit device or the like, perform and/or implement the systems, methods and processes described herein. Specifically, any of the steps, operations or functions described above may be implemented in the form of such computer executable instructions. Computer readable storage media includes volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CD ROM, digital versatile disks (DVD) or other optical disk storage, magnetic cassettes, magnetic tape, magnetic disk storage or other magnetic storage devices, or any other physical medium which can be used to store the desired information and which can be accessed by a computer.

According to yet another aspect of the application, a non-transitory computer-readable or executable storage medium for storing computer-readable or executable instructions is disclosed. The medium may include one or more computer-executable instructions such as disclosed above in the plural call flows. The computer executable instructions may be stored in a memory and executed by a processor disclosed above in FIGS. 1C and 1F, and employed in devices including a node such as for example, end-user equipment. In particular, the UE as shown for example in FIGS. 1B and 1E is conditioned to perform the instructions of enabling synchronization of nodes in an IAB network through OTA signaling.

While the systems and methods have been described in terms of what are presently considered to be specific aspects, the application need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

What is claimed is:

1. An apparatus on a network comprising:
a non-transitory memory including instructions stored thereon for resynchronization; and
a processor operably coupled to the non-transitory memory configured to execute the instructions of:
performing downlink (DL) synchronization with an integrated and access backhaul (IAB) parent node, where synchronization includes searching for a synchronization signal/physical broadcast channel (SS/PBCH) of the parent IAB node distinct from other SS/PBCH signals of the parent IAB node assigned for user equipments (UEs);
performing random access to obtain a timing advance (TA) from the parent IAB node;
receiving a timing adjustment (T_{adj}) from the parent IAB node for the resynchronization separate from the TA; and
based on the T_{adj} and TA, applying a timing alignment of DL transmissions for the UEs and child nodes, and/or
based on the T_{adj} and TA, applying a timing alignment of uplink (UL) transmission to the parent IAB node.

2. The apparatus of claim 1, wherein the T_{adj} is received through a multicast control information transmission from the parent IAB node.

3. The apparatus of claim 1, wherein the T_{adj} is received through a unicast control information transmission from the parent IAB node.

4. The apparatus of claim 1, wherein the T_{adj} and TA are received in a same control information transmission from the parent IAB node.

5. The apparatus of claim 1, wherein the T_{adj} and TA are received from separate control information transmissions from the parent IAB node.

6. The apparatus of claim 1, wherein the processor is further configured to run a resynchronization timer to count down a period from time of reception of the T_{adj}.

7. The apparatus of claim 1, where the TA is applied on expiration of a counter for one or more of the DL and UL transmissions.

8. The apparatus of claim 1, wherein a gap occurs between transmissions based on prior timing and transmissions depending on timing after resynchronization, wherein the instructions of monitoring the DL is restricted in the gap, and wherein transmitting the UL is restricted in the gap.

9. The apparatus of claim 1, wherein the processor is further configured to execute the instructions of resynchronizing to a second parent with a synchronization period (Tₛₚ) configured through the network.

10. The apparatus of claim 9, wherein the processor is further configured to execute the instructions of searching for a SS/PBCH block of the second parent node within the Tₛₚ to obtain a new timing for the DL synchronization with a second parent node.

11. An apparatus on a network comprising:
a non-transitory memory including instructions stored thereon for handling resynchronization in a multi-hop deployment; and
a processor operably coupled to the non-transitory memory configured to execute the instructions of:
monitoring a downlink (DL) transmission from a first parent node in the network;
obtaining, from the DL transmission, an indication of the resynchronization located in a first frame of the first parent node;
determining a timing advance to the first parent node (TAₚₐᵣₑₙₜ₁) on an uplink (UL) backhaul of the apparatus;
evaluating a timing advance to a second parent node (TAₚₐᵣₑₙₜ₂) on the network,
determining a timing adjustment (T_{adj}) for the resynchronization; and
sending the T_{adj} to a child node for resynchronization.

12. The apparatus of claim 11, wherein propagation time of the second parent node (PT2) is a sum of a propagation time of the first parent node (PT1) and a difference between an observed frame time of the first parent node on the DL and an observed frame time of the second parent node on the DL.

13. The apparatus of claim 12, wherein the T_{adj} is a difference between the PT1 and PT2.

14. The apparatus of claim 13, wherein the T_{adj} occurs at a frame boundary between the first parent node and the second parent node.

15. The apparatus of claim 11, wherein the T_{adj} occurs after a second frame.

16. The apparatus of claim 15, wherein the processor is further configured to execute the instructions of sending a reference time indicating a beginning of the second frame.

17. The apparatus of claim 11, wherein the processor is further configured to execute the instructions of providing a synchronization period (Tₛₚ) to the child node based upon a change in synchronization scheme or topology.

18. The apparatus of claim 17, wherein the child node resynchronizes with a synchronization signal/physical broadcast channel (SS/PBCH) to obtain a new timing.

19. The apparatus of claim 11, wherein the apparatus is configured for integrated access and backhaul (IAB).

20. The apparatus of claim 11, wherein the network includes over-the-air synchronization.
